(19) United States
(12) Patent Application Publication
(10) Pub. No.: US 2004/0221267 A1
(43) Pub. Date: Nov. 4, 2004

(54) Computer program product, data processing system, and method for installing or configuring computer software

(75) Inventors: Ryan A. Chase, Toronto (CA); Maxim A. Maltchevski, Thornhill (CA); Darin C. McBride, Sherwood Park (CA)

Correspondence Address: Cynthia S. Byrd, International Business Machines, Intellectual Property Law, 11400 Burnet Road, Austin, TX, 78758, US

(73) Assignee: INTERNATIONAL BUSINESS MACHINES CORPORATION, ARMONK, NY

(21) Appl. No.: 10/426,231

(22) Filed: Apr. 29, 2003

(51) Int. Cl. G06F 9/44; G06F 13/00

(52) U.S. Cl. 717/121; 719/328

(57) ABSTRACT

A method and system for installing and configuring a software product on a data processing system that associates setup interface panels with individual components of the software product and that builds a setup interface based upon the data processing system context at the time of installation and configuration. Components may be available on an installation media or may already be installed on the data processing system. A list of all available components is gathered and a corresponding list of all panels associated with the available components is created. Panels may have conditions governing whether or not they are displayed and those conditions may include the state of their associated component. The panel list is filtered to remove any panels that, because of their conditions, are not to be displayed in the current system context. The setup interface is built based upon the filtered panel list and it is displayed to the user. The system context includes the state of the components, the setup type and the setup tasks. Panels may register for notification as the system context changes in the course of setup in order for the panel to be added to or removed from the setup interface.

### FIELD OF THE INVENTION

The present invention relates to computer software in general; and, in particular, the present invention relates to a computer program product, method and data processing system for installing or configuring computer software.

### BACKGROUND OF THE INVENTION

In contemporary complex software development, it is common for a complex computer software program to evolve into a software product line made up of a number of computer software products (hereinafter referred to as software products). Typically, a software product line includes a standard product and other more complex or more specialized variations of the standard product. The more complex products may have additional features or “add-ons” that the standard product does not have. There is some overlap between the features and function available in each product, as each likely shares a common core of functionality. Some products have a larger list of function than others, some products are meant for very specific purposes and some products can be used in a wider range of purposes.

In the context of installation and configuration of software, each software product can be broken down into a number of atomic components, and indeed the entire software product line can be broken down into a list of components. These components are arranged or configured in a number of different ways in each different software product which is part of the software product line. Components can be grouped in different ways to create component groups that describe a certain function or set of functionality. Components and component groups can be grouped in different ways to create products.

An aspect commonly found in component-based software is a “signature component”. This is a dedicated component that is used to identify a product. Typically, it does not contain any functions; it is simply used as a marker to identify a software product and is of particular use in determining if a software product is installed. The use of a signature component as a representation of a product allows the system to deal uniformly with components with the result that special handling for products is not required.

Computer program products typically include a setup wizard or interface that guides a user through the selection of certain features or options and any customization available. Based upon the user's selections, the setup wizard directs a setup engine to perform the tasks necessary to install and configure the components making up the desired software product. The setup wizard is usually a graphical user interface (GUI) module that displays a set of interface panels to guide the user through any selection or customization necessary for each component of the product.

A problem that arises, especially in the case of large and complex software product lines, is that any developmental change made to a software product, such as the addition, deletion, or modification of a constituent component, likely necessitates a corresponding change to the setup wizard. A developer may need to alter individual interface panels or add or remove features from the setup wizard. Accordingly, as the product line evolves, considerable effort goes into rewriting and reconfiguring the setup engine.

Another problem that arises with complex software product lines is that a wide variety of different customer configurations must be supported and many customers will desire customized installations or configurations of one or more products or a mixture of products. Designing a setup engine to accommodate all of the various possibilities in advance is expensive and time-consuming.

Accordingly, a solution that addresses, at least in part, this and other shortcomings is desired.

### SUMMARY OF THE INVENTION

The present invention provides a computer program product, method, article and data processing system for installing or configuring a software product that associates setup interface panels with particular components of the software product and that builds a setup interface based upon a system context at the time of installation and configuration. The system context includes the state of various components, including whether or not the components have been installed on the system or configured yet. The inclusion of some of the individual panels in the setup interface depends upon the state of the component associated with the interface panel. Accordingly, the present invention builds a setup interface customized to the state of the components that make up the software product.

In one aspect, the present invention provides a method for building a setup interface module for installing and configuring a software product on a data processing system, the software product including a plurality of components and a plurality of interface panels, each interface panel being associated with at least one component, the interface panels having associated panel conditions determining whether display of the interface panel is necessary, the data processing system having a system context, the system context including a state of each of the components. The method includes the steps of building a component list including available components, building a panel list containing a listing of the interface panels associated with the available components contained in the component list, removing unnecessary interface panels from the panel list based upon the associated panel conditions and the system context, thereby producing a reduced panel list, the setup interface module being buildable based upon the filtered panel list.

In another aspect, the present invention provides a computer program product having a computer-readable medium tangibly embodying computer executable instructions for building a setup interface module for installing and configuring a software product on a data processing system, the software product including a plurality of components and a plurality of interface panels, each interface panel being associated with at least one component, the interface panels having associated panel conditions determining whether display of the interface panel is necessary, the data processing system having a system context, the system context including a state of each of the components. The medium includes computer executable instructions for building a component list including available components, computer executable instructions for building a panel list containing a listing of the interface panels associated with the available components contained in the component list, computer executable instructions for removing unnecessary interface panels from the panel list based upon the associated panel conditions and the system context, thereby producing a reduced panel list, the setup interface module being buildable based upon the filtered panel list.

In a further aspect, the present invention provides a data processing system for building a setup interface module for installing and configuring a software product on the data processing system, the software product including a plurality of components and a plurality of interface panels, each interface panel being associated with at least one component, the interface panels having associated panel conditions determining whether display of the interface panel is necessary, the data processing system having a system context, the system context including a state of each of the components. The data processing system includes means for building a component list including available components, means for building a panel list containing a listing of the interface panels associated with the available components contained in the component list, means for removing unnecessary interface panels from the panel list based upon the associated panel conditions and the system context, thereby producing a reduced panel list, the setup interface module being buildable based upon the filtered panel list.

In yet a further aspect, the present invention provides an article including a computer-readable signal-bearing bearing medium for use on a network and means in the medium for directing a data processing system to implement a method for building a setup interface module for installing and configuring a software product on a data processing system, the software product including a plurality of components and a plurality of interface panels, each interface panel being associated with at least one component, the interface panels having associated panel conditions determining whether display of the interface panel is necessary, the data processing system having a system context, the system context including a state of each of the components. The medium includes means for building a component list including available components, means for building a panel list containing a listing of the interface panels associated with the available components contained in the component list, means for removing unnecessary interface panels from the panel list based upon the associated panel conditions and the system context, thereby producing a reduced panel list, the setup interface module being buildable based upon the filtered panel list.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows, in diagrammatic form, a computer system for installing a computer program product, according to the present invention;

FIG. 2 shows, in flowchart form, a method of installing or configuring a computer program product, according to the present invention; and

FIG. 3 shows, in diagrammatic form, an embodiment of a setup module according to the present invention.

Similar references are used in different figures to denote similar components or features.

### DESCRIPTION OF SPECIFIC EMBODIMENTS

The following detailed description of the embodiments of the present invention does not limit the implementation of the invention to any particular computer programming language. The present invention may be implemented in any computer programming language provided that the OS (Operating System) provides the facilities that may support the requirements of the present invention. A preferred embodiment is implemented in the Java computer programming language (or other computer programming languages in conjunction with Java). Any limitations presented would be a result of a particular type of operating system or computer programming language and would not be a limitation of the present invention.

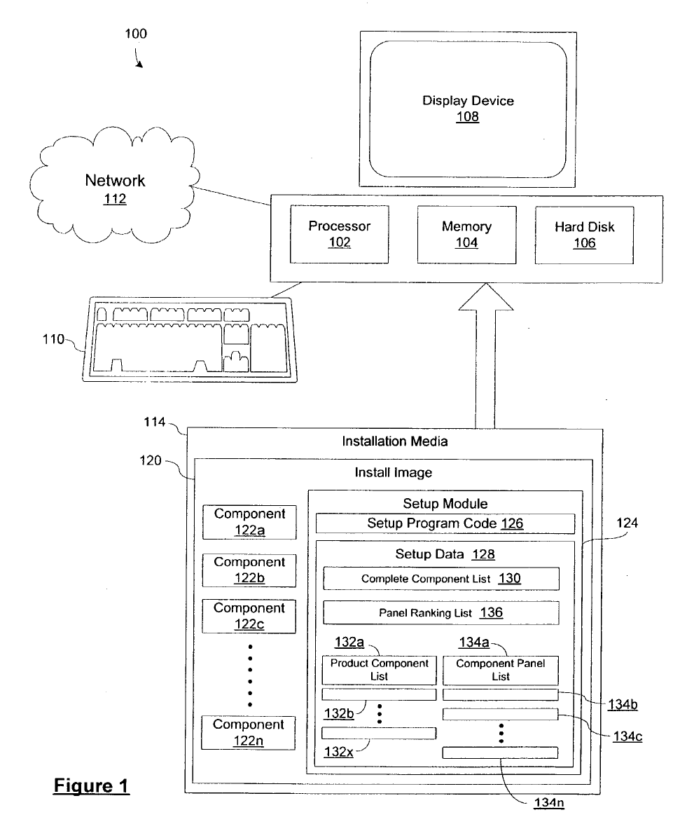

Reference is first made to FIG. 1, which shows, in diagrammatic form, a computer system 100 for installing and/or configuring a software product, according to the present invention. The computer system includes a processor 102, a memory 104, a hard disk 106, a display device 108, an input device 110, and a network connection 112.

The software product to be installed and/or configured includes one or more products from a line of software products. Each product in the line of software products is made up of a specific selection from a plurality of components 122a to 122n. The components 122 can be mixed and matched to create one or more products from the line of software products.

In one embodiment, the components 122 are present in an install image 120 accessible to the computer system 100. The install image 120 may be encoded on an installation media 114. The installation media 114 includes a computer-readable storage media, such as a compact disc or a floppy disk, or a computer-readable signal-bearing medium. In another embodiment, the install image 120 may be accessible from a remote location through the network connection 112.

The install image 120 further includes a setup module 124 for building a setup interface and installing and/or configuring one or more of the software products based upon the available components 122. The setup module 124 includes setup program code 126 and setup data 128. The setup data 128 includes a complete component list 130, a product component list 132a to 132x for each product, a component panel list 134a to 134n for each of the plurality of components 122a to 122n, and a panel ranking list 136.

In another embodiment, some or all of the components 122 are installed upon the computer system 100. The components 122 may be stored upon the hard disk 106 and they may or may not be configured. This situation typically arises if one or more of the products in the software product line have previously been installed and/or configured on the computer system 100. In this embodiment, the setup module 124 may be installed upon the computer system 100, and may operate from the installed copy.

In still another embodiment, an install image 120 having the plurality of components 122a to 122n is available and some of the components 122 are already installed and/or configured upon the computer system 100. The setup module 124 may operate from a copy on the install image 120 or from a copy installed on the computer system 100. In this embodiment, the setup module 124 builds a setup interface based upon the available components 122, which includes those on the install image 120 and those already installed and/or configured on the computer system 100.

The complete component list 130 in the setup module 124 lists all of the components 122 in the product line. Each product in the line of products is made up a specific selection of the plurality of components 122a to 122n. Thus, each product component list 132a to 132x list the specific components 122 that are required to create a particular product. For example, if the plurality of components 122a to 122n included ten separate components, a simple product may include the first five components, whereas a more complicated product may include all ten components.

Each component panel list 134 lists the GUI interface panels, if any, associated with the corresponding component 132. Each component 122 may have a variety of interface panels associated with it, depending upon a number of factors, including the extent to which the installation of the component 122 is context specific and requires user input to choose between various installation or configuration options. Some of the interface panels may only be intended for display in certain contexts, such as during a custom installation setup, and not in other contexts, such as in a standard installation. Some of the interface panels may be intended for display when installing the component 122 to the computer system 100 and some may be for configuring the component 122 once it is installed, meaning that the state of the component 122 will determine whether or not certain interface panels are included for display by the setup interface. Each interface panel may include one or more conditions governing whether or not it is displayed.

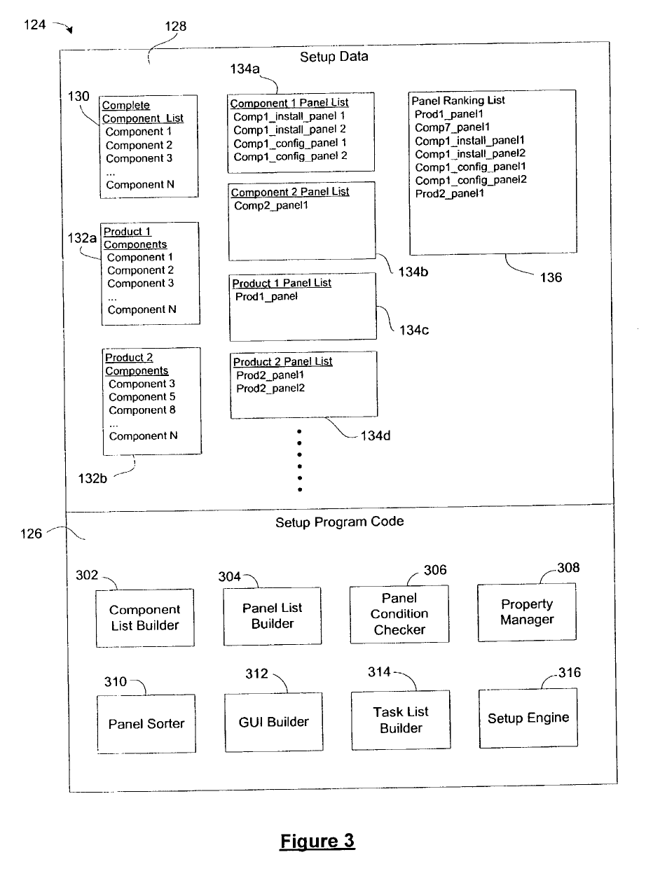

Reference is now made to FIG. 3, which shows, in diagrammatic form, an embodiment of the setup module 124 according to the present invention. In this example, the setup module 124 includes information regarding two products.

The setup module 124 includes the setup data 128 and the setup program code 126. The setup data 128 includes the complete component list 130, the panel ranking list 136, the product component lists 132a and 132b, and the component panel lists 134a, 134b, 134c, and 134d. Two of the component panel lists 134c and 134d list interface panels associated with the two products, respectively, as opposed to a particular component.

The setup program code 126 includes a set of submodules for performing the functions of the setup module 124. In particular, the setup program code 126 includes a component list builder 302 and a panel list builder 304. One of the first tasks of the setup program code 126 is to build a list of the components available for installation and/or configuration. This function is performed by the component list builder 302. The panel list builder 304 compiles a list of the interface panels associated with the components identified by the component list builder 302. The panel list builder 304 refers to the component panel lists 134 to determine the interface panels to include in the panel list.

The setup program code 126 also includes a panel condition checker 306 and a property manager 308. The property manager 308 monitors the state or value of a number of properties. Many of the interface panels have conditions governing whether or not they are displayed, such as a condition on the type of installation being performed. These conditions may relate to the state or value of certain properties monitored by the property manager 308. Accordingly, the panel condition checker 306, in concert with the property manager 308, assesses whether any interface panels identified by the panel list builder 304 need not be displayed due to the state of certain properties.

The setup program code 126 further includes a panel sorter 310 for ordering the interface panels based upon the panel ranking list 136, a GUI builder 312 for creating a setup interface using the interface panels, and a task list builder 314 for creating a list of installation and configuration tasks. The list of installation and configuration tasks may then be provided to a setup engine 316 for execution.

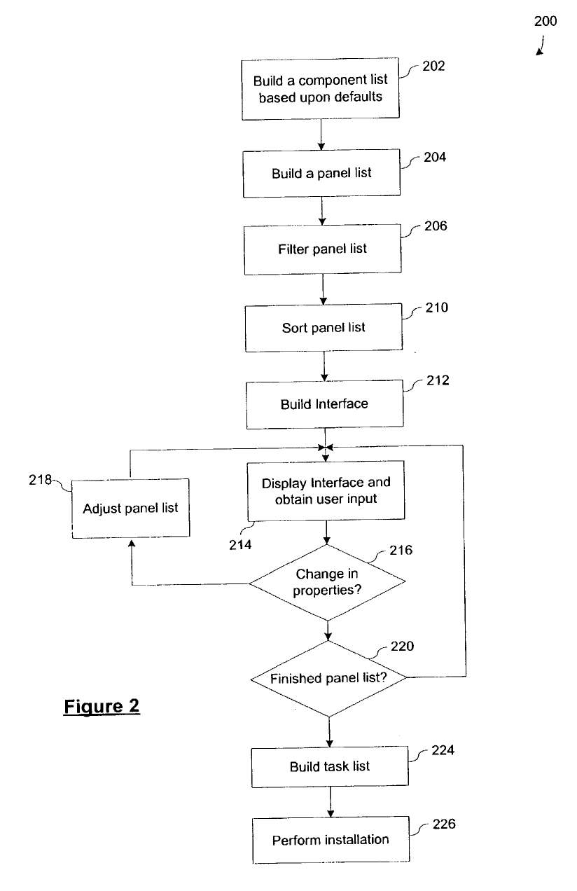

Reference is now made to FIG. 2, which shows, in flowchart form, a method 200 for installing or configuring a computer program product, according to the present invention.

The method 200 begins in step 202 when the setup module 124 (FIG. 3) builds a list of available components specific to the system context of the computer system 100 (FIG. 1). The system context of the computer system 100 includes its configuration and any components available for installation and/or configuration, including those present on an installation media 114, if any, or those already installed and/or configured on the computer system 100. Accordingly, the list of available components includes any components 122 (FIG. 1) in the install image 120 (FIG. 1), if one is available, and any components 122 already installed on the computer system 100 and stored on, for example, the hard disk 106 (FIG. 1).

The task of listing the available components is performed by the component list builder 302 (FIG. 3). In order to perform this task quickly without exhaustively scanning all of the installed software on the computer system 100, the component list builder 302 first checks to see if any of the signature components are installed. If it detects the signature component for a particular product, then it also scans the computer system 100 for the remaining components 122 that are included in that product. The component list builder 302 will be aware of what components 122 are associated with which product based upon the product component lists 132 (FIG. 1) contained in the setup data 128 (FIG. 1).

The list of available components also includes the state of each component. Components 122 may by installed, available for installation and selected, or available for installation and not selected. In addition, certain components 122 may require configuration as well as installation. Accordingly, these types of components may have the states: configured, pending configuration, and not configured. The possible component states are shown in the following table:

| | Not | Pending | |
|---|---|---|---|
| | configured | configuration | Configured |
| Installed | 1 | 2 | 3 |
| Available for | 4 | 5 | — |
| installation and | | | |
| selected | | | |
| Available for | 6 | — | — |
| installation and | | | |
| not selected | | | |

Information regarding the state of each component 122 may come from default settings and from scans of the system context, i.e. the current state of the computer system 100. For example, any components 122 found on the install image 120 on the installation media 114 (FIG. 1) are considered available for installation. Depending upon the product being installed, all of the components 122 may be selected for installation or a subset of the components 122 may be selected for installation. Accordingly, many of the components 122 will be in state number 4 or 5 and some may be in state 6.

Any components 122 found on the computer system 100 are considered ‘installed’, and they may or may not be already configured, pending configuration, or not configured.

After building the list of available components 122 and each component's current state, the method 200 proceeds to step 204 to build a panel list. Each component 122 has an associated component panel list 134 which identifies the interface panels associated with installation and/or configuration of the component 122, if any. A component 122 may have no associated interface panels, a single associated interface panel, or many associated interface panels.

The panel list is created by the panel list builder 304. The panel list builder 304 reads the list of available components one by one, and for each component 122, reads the associated component panel list 134 for that component 122, and adds the identified interface panels to the panel list. Accordingly, based upon the list of available components, the panel list identifies every interface panel that could potentially be needed, irrespective of the system context.

In step 206, the panel list is then filtered to reduce the identified interface panels to only those interface panels necessary in view of the system context.

The filtering process includes assessing the system context, which includes the value of a number of properties. In one embodiment, the properties which are evaluated include the component state, the setup tasks, and the setup type. Based upon the state of these properties, certain panels may not be needed. Other properties may be included in the filtering process, as may be appropriate to a particular embodiment or a particular interface panel. Certain properties, such as the setup type and setup tasks, are initially assigned default values without first checking the system context. Other properties such as the component state property for each component 122 are determined by scanning the computer system 100 to determine the correct value for the property.

Each interface panel may have one or more conditions governing whether or not the interface panel is to be displayed to a user during an installation or configuration. Some of these conditions may depend upon the value of certain properties. For example, a particular interface panel may only be intended for display based upon a certain component state, setup type, or setup task.

The filtering step 206 is performed by the panel condition checker 306 using the property values that are being monitored by the property manager 308. The panel condition checker 306 checks the current value of each property and compares it to the condition governing whether or not the panel is displayed. During this stage the interface panels also register with the property manager 308 in order to receive notification when the value of one or more properties change.

The component state property refers to the state of the component 122 associated with a particular interface panel. The possible component states are outlined in the table above. An interface panel may include a condition that the associated component 122 must be in one or more particular states for the interface panel to be displayed. For example, the interface panel may be intended for display only in the case where the component 122 is already installed, but not yet configured. Another interface panel for the same component 122 may only be intended for display if the component 122 is available for installation. If the value of the component state property does not match any of the component states for which the interface panel should be displayed, then the interface panel is removed from the panel list.

The setup tasks property indicates which setup tasks the setup module 124 will perform. In one embodiment, the setup module 124 is capable of performing the following setup tasks: INSTALL, CONFIGURE, INSTANCE_CREATE, INSTANCE_UPDATE. When the setup module 124 is run from the installation media 114, the setup tasks are limited to INSTALL, CONFIGURE, and INSTANCE_CREATE by default, and when the setup module 124 is installed on the computer system 100 and run from the installed copy, the default setup tasks are limited to CONFIGURE and INSTANCE_CREATE.

The first time a product is installed on the computer system 100, the setup module 124 must be run from the installation media 114 or from a remote location over the network 112 since it is not yet present on the computer system 100. Accordingly, the INSTALL and CONFIGURE tasks are required, and the user can choose whether or not the other tasks are performed. On subsequent installations and when the setup module 124 is run from an installed copy, the INSTALL task cannot be performed and the user can select from the other tasks they want to perform.

An interface panel may have a condition regarding the setup tasks for which it should be displayed. If the value for the setup tasks property does not include any of the setup tasks for which the interface panel should be displayed, then the interface panel is removed from the panel list.

The setup type property reflects the type of setup being performed. In one embodiment, the types of setups include TYPICAL, CUSTOM, COMPACT, and COMPLETE. Often in practice the main difference in setup types is between CUSTOM and all the other setup types. Certain interface panels are only applicable for the CUSTOM setup type and are not applicable for all other setup types. In another embodiment, CUSTOM may be referred to as the ADVANCED setup type. An interface panel may have a list of setup types for which it should be displayed. If the value of the setup type property is not one of the setup types for which the interface panel should be displayed, then the interface panel is removed from the panel list.

Once the panel condition checker 306 has applied the conditions for each interface panel in the panel list and has removed any unnecessary interface panels, the resulting list is a filtered panel list.

The system context, i.e. the value of some of the properties used to filter the panel list, may change in the course of installation or configuration. For example, once the setup interface is built and displayed to the user, the user may change certain settings, including the type of setup performed or the setup tasks. As will be explained below, the setup interface dynamically adapts to this change by adding or removing interface panels as necessary. The property manager 308 tracks the changes in property values and sends notification to any interface panels that have registered to receive notice of a change in that property. The conditions of each such interface panel are then checked to assess whether the change in property value should cause the removal or addition of the interface panel to the setup interface.

In one embodiment, after the panel list is filtered, the filtered panel list is sorted by the panel sorter 310, using the panel ranking list 136 contained in the setup data 128. The result is a sorted panel list detailing the interface panels to be displayed to the user, sorted in the order that they are to be displayed.

In step 212, this sorted list of panels is passed to the GUI builder 312 which creates a setup interface using the list of panels to be displayed along with other GUI specific information.

Once built, the setup interface is then displayed to the user in step 214. The setup interface chooses interface panels for display to the user based upon the sorted panel list. The user interacts with the interface panels as appropriate using the input device 110 (FIG. 1), such as a mouse or keyboard. The user may be prompted to confirm certain settings or choose between certain options regarding the installation or configuration of the product.

As the user goes through the interface panels, the property manager assesses, in step 216, whether any properties have changed. If so, then the appropriate notification, if any, is sent to any interface panels registered with the property manager 308 for notices relating to that particular property. If the change necessitates the addition or deletion of one or more interface panels from the panel list, then in step 218 the sorted panel list is adjusted to incorporate the change. Accordingly, the setup interface dynamically adjusts to changes in the system context.

Once the setup interface has, in step 220, displayed all the interface panels in the sorted panel list, then the setup module 124 proceeds to step 224, wherein it builds a task list containing all the tasks for the setup engine 316 (FIG. 3) to execute in order to install and/or configure the product. This is done, in part, by reading information from the property manager 308 to determine which tasks need to be performed by the setup engine 316 and what values to use when performing those tasks. After the list of tasks has been prepared by the task list builder 314, in step 226 this list is passed to the setup engine 316 and the setup engine 316 performs the installation and configuration tasks in the task list. In one embodiment, the task list builder 314 creates a response file, which is a text file containing data in a series of key-value pairs, and the setup engine 316 performs the installation and configuration of components by reading the response file. The setup engine 316 may be configured to provide progress notification to the setup interface, which may then display progress indicators to the user through one or more GUI panels.

Examples of other kinds of properties that may by monitored by the property manager 308 and that may impact the display of certain interface panels include the type of operating system present on the computer system 100, the user/password information management system used by the computer system 100, and a location property reflecting whether or not some aspect of the product, such as a database, is maintained locally on the computer system 100 or on a remote site accessible through the network connection 112. Other properties could include a disabled user property, wherein a different set of panels is used in the case of a disabled user.

Although the above-described embodiments of the present invention include a setup module 124 having a complete component list 130 and product component lists 132, those of ordinary skill in the art will appreciate that such lists are not necessary in all embodiments to build a list of available components. One alternative embodiment includes a system scan of all software installed on the computer system 100 to create the list and the filtering of any unrelated software from the list based upon a naming convention for the components 122 related to the product line.

Those skilled in the art will also appreciate that although embodiments of the present invention have been described as including GUI interface panels, other methods of displaying information to the user and eliciting information from the user may also be employed. For example, simple textual descriptions or queries could be displayed.

In yet another embodiment, similar to the GUI panels that are displayed to the user, the present invention may include textual instructions about installation/configuration that are associated with each component. Accordingly, instead of resulting in a setup interface, the present invention provides customized installation instructions based upon the association of instructions to individual components. Other elements may be associated with individual components, including cost values that could be used to build customized pricing for particular product installations.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

The embodiments of the invention in which an exclusive property or privilege is claimed are defined as follows:

1. A method for building a setup interface module for installing and configuring a software product on a data processing system, the software product including a plurality of components and a plurality of interface panels, each interface panel being associated with at least one component, said interface panels having associated panel conditions determining whether display of said interface panel is necessary, said data processing system having a system context, said system context including a state of each of said components, said method comprising the steps of:
a) building a component list including available components
b) building a panel list containing a listing of said interface panels associated with the available components contained in said component list, and
c) removing unnecessary interface panels from said panel list based upon said associated panel conditions and said system context, thereby producing a reduced panel list, said setup interface module being buildable based upon said reduced panel list.

2. The method claimed in claim 1, wherein said data processing system includes an installation media having encoded thereon one or more uninstalled components, and wherein said component list includes said uninstalled components.

3. The method claimed in claim 1, wherein said data processing system includes a hard disk having encoded thereon one or more installed components, and wherein said component list includes said installed components.

4. The method claimed in claim 1, wherein said system context includes at least one property, and wherein said step of removing includes removing interface panels based upon said associated panel conditions and the value of said property, said associated panel conditions identifying one or more values of said property for which said interface panel is to be displayed.

5. The method claimed in claim 4, wherein said property includes a component state property for each of said plurality of components, the value of said component state property indicating whether said component is installed and whether said component is configured.

6. The method claimed in claim 4, wherein said property includes a setup task property, the value of said setup task property indicating a selection of setup tasks to be performed.

7. The method claimed in claim 4, wherein said property includes a setup type property, the value of said setup type property indicating the type of setup operation to be performed.

8. The method claimed in claim 4, wherein said software product includes a property manager for monitoring the value of said property, and wherein said interface panels register with said property manager for notification of changes in the value of said property.

9. The method claimed in claim 8, further including a step of invoking said setup interface module to display said interface panels according to said reduced panel list.

10. The method claimed in claim 9, further including a step of notifying a registered interface panel of a change in the value of said property.

11. The method claimed in claim 10, further including the steps of receiving user input during said display of said interface panels, building a task list including the tasks for installation and configuration of the software product, and installing and configuring said software product in accordance with said task list.

12. A computer program product having a computer-readable medium tangibly embodying computer executable instructions for building a setup interface module for installing and configuring software product on a data processing system, the software product including a plurality of components and a plurality of interface panels, each interface panel being associated with at least one component, said interface panels having associated panel conditions determining whether display of said interface panel is necessary, said data processing system having a system context, said system context including a state of each of said components, the computer executable instructions comprising:
(a) computer executable instructions for building a component list including available components;
(b) computer executable instructions for building a panel list containing a listing of said interface panels associated with the available components contained in said component list; and
(c) computer executable instructions for removing unnecessary interface panels from said panel list based upon said associated panel conditions and said system context, thereby producing a reduced panel list, said setup interface module being buildable based upon said reduced panel list.

13. The computer program product claimed in claim 12, wherein said [I3] data processing system includes an installation media having encoded thereon one or more uninstalled components, and wherein said component list includes said uninstalled components.

14. The computer program product claimed in claim 12, wherein said data processing system includes a hard disk having encoded thereon one or more installed components, and wherein said component list includes said installed components.

15. The computer program product claimed in claim 12, wherein said system context includes at least one property, and wherein said computer executable instructions for removing include computer executable instructions for removing interface panels based upon said associated panel conditions and the value of said property, said associated panel conditions identifying one or more values of said property for which said interface panel is to be displayed.

16. The computer program product claimed in claim 15, wherein said property includes a component state property for each of said plurality of components, the value of said component state property indicating whether said component is installed and whether said component is configured.

17. The computer program product claimed in claim 15, wherein said property includes a setup task property, the value of said setup task property indicating a selection of setup tasks to be performed.

18. The computer program product claimed in claim 15, wherein said property includes a setup type property, the value of said setup type property indicating the type of setup operation to be performed.

19. The computer program product claimed in claim 15, further including computer executable instructions for creating a property manager for monitoring the value of said property, and wherein said interface panels register with said property manager for notification of changes in the value of said property.

20. The computer program product claimed in claim 19, further including computer executable instructions for notifying a registered interface panel of a change in the value of said property.

21. The computer program product claimed in claim 20, further including computer executable instructions for receiving user input, computer executable instructions for building a task list including the task for installation and configuration of the software product, and computer executable instructions for a setup engine, said setup engine being responsive to said task list for installing and configuring the software product.

22. A data processing system for building a setup interface module for installing and configuring a software product on the data processing system, the software product including a plurality of components and a plurality of interface panels, each interface panel being associated with at least one component, said interface panels having associated panel conditions determining whether display of said interface panel is necessary, said data processing system having a system context, said system context including a state of each of said components, said data processing system comprising:
(a) means for building a component list including
available components;
(b) means for building a panel list containing a listing of said interface panels associated with the available components contained in said component list;
(c) means for removing unnecessary interface panels from said panel list based upon said associated panel conditions and said system context, thereby producing a reduced panel list, said setup interface module being buildable based upon said reduced panel list.

23. The data processing system claimed in claim 22, further including an [I5] installation media having encoded thereon one or more uninstalled components, and wherein said component list includes said uninstalled components.

24. The data processing system claimed in claim 22, further including a hard disk having encoded thereon one or more installed components, and wherein said component list includes said installed components.

25. The data processing system claimed in claim 22, wherein said system context includes at least one property, and wherein said means for removing includes means for removing interface panels based upon said associated panel conditions and the value of said property, said associated panel conditions identifying one or more values of said property for which said interface panel is to be displayed.

26. The data processing system claimed in claim 25, wherein said property includes a component state property for each of said plurality of components, the value of said component state property indicating whether said component is installed and whether said component is configured.

27. The data processing system claimed in claim 25, wherein said property includes a setup task property, the value of said setup task property indicating a selection of setup tasks to be performed.

28. The data processing system claimed in claim 25, wherein said property includes a setup type property, the value of said setup type property indicating the type of setup operation to be performed.

29. The data processing system claimed in claim 25, further including monitor means for monitoring the value of said property, and wherein said interface panels register with said monitor means so as to receive notification of changes in the value of said property.

30. The data processing system claimed in claim 29, further including means for invoking said setup interface module to display said interface panels according to said reduced panel list.

31. The data processing system claimed in claim 30, further including means for notifying a registered interface panel of a change in the value of said property.

32. The data processing system claimed in claim 31, further including means for receiving user input during said display of said interface panels, means for building a task list including the tasks for installation and configuration of the software product, and means for installing and configuring said software product in accordance with said task list.

33. An article, comprising:
(a) computer-readable signal-bearing medium for use on a network; and
(b) means in the medium for directing a data processing system to build a setup interface module for installing and configuring a software product on the data processing system, the software product including a plurality of components and a plurality of interface panels, each interface panel being associated with at least one component, said interface panels having associated panel conditions determining whether display of said interface panel is necessary, said data processing system having a system context, said system context including a state of each of said components, said means in the medium comprising:
(i) means for building a component list including available components;
(ii) means for building a panel list containing a listing of said interface panels associated with the available components contained in said component list;
(iii) means for removing unnecessary interface panels from said panel list based upon said associated panel conditions and said system context, thereby producing a reduced panel list, said setup interface module being buildable based upon said filtered panel list.

34. The article claimed in claim 33, wherein said data processing system includes an installation media having encoded thereon one or more uninstalled components, and wherein said component list includes said uninstalled components. [I6]

35. The article claimed in claim 33, wherein said data processing system includes a hard disk having encoded thereon one or more installed components, and wherein said component list includes said installed components.

36. The article claimed in claim 33, wherein said system context includes at least one property, and wherein said means for removing includes means for removing interface panels based upon said associated panel conditions and the value of said property, said associated panel conditions identifying one or more values of said property for which said interface panel is to be displayed.

37. The article claimed in claim 36, wherein said property includes a component state property for each of said plurality of components, the value of said component state property indicating whether said component is installed and whether said component is configured.

38. The article claimed in claim 36, wherein said property includes a setup task property, the value of said setup task property indicating a selection of setup tasks to be performed

39. The article claimed in claim 36, wherein said property includes a setup type property, the value of said setup type property indicating the type of setup operation to be performed.

40. The article claimed in claim 36, further including monitor means for monitoring the value of said property, and wherein said interface panels register with said monitor means so as to receive notification of changes in the value of said property.

41. The article claimed in claim 40, further including means for invoking said setup interface module to display said interface panels according to said reduced panel list.

42. The article claimed in claim 41, further including means for notifying a registered interface panel of a change in the value of said property.

43. The article claimed in claim 42, further including means for receiving user input during said display of said interface panels, means for building a task list including the tasks for installation and configuration of the software product, and means for installing and configuring said software product in accordance with said task list.
